(19) United States
(12) Patent Application Publication
(10) Pub. No.: US 2003/0168781 A1
(43) Pub. Date: Sep. 11, 2003

(54) Method for protecting reinforcement in concrete from chloride corrosion

(76) Inventors: Pertti Kukkonen, Helsinki (FI); Risto Mannonen, Espoo (FI)

Correspondence Address: JOEL D. SKINNER, JR., SKINNER AND ASSOCIATES, 212 COMMERCIAL ST., HUDSON, WI, 54016, US

(21) Appl. No.: 10/276,379

(22) PCT Filed: May 15, 2001
(86) PCT No.: PCT/FI01/00470

(30) Foreign Application Priority Data
May 15, 2000 (FI) 20001147

(51) Int. Cl. B29C 71/00

(52) U.S. Cl. 264/340

(57) ABSTRACT

The invention relates to a method for protecting reinforcement in concrete from the corrosion caused by chloride ions. According to the method, metallic copper and/or copper compounds are added to the concrete mass, in which mass the copper reacts with the chloride to form salts with a chloride content and of low solubility, thus substantially reducing the danger of steel corrosion caused by chloride. The copper or copper compound can also be brought into close contact with the concrete, for example in the form of a repair mortar.

The present invention relates to a method, by means of which reinforcement in concrete can be protected from so-called chloride corrosion.

The alkali environment of concrete protects the steel in reinforced concrete structures from corrosion. Corrosion can only start once the carbon dioxide in the air, in the presence of water and oxygen, neutralizes the alkali environment around the steel. Chlorides form an exception to the aforesaid phenomenon, because, in the presence of chlorides, steel corrosion may also start while there is still an alkali environment around the steel.

Indeed, the penetration of chlorides into concrete structures is, in many cases, one of the factors that essentially limits the life of reinforced concrete structures. The corrosion of the reinforcing steel causes not only a reduction in the cross-sectional area of the steel and thus a reduction in its load-bearing ability, but also causes spalling of the concrete cover around the steel, due to the large volume of the corrosion products compared to the volume of the original iron. At this stage, the life of a concrete structure can generally be reckoned to have ended.

The main attempts to limit the penetration of chlorides into concrete have been by making the concrete as dense as possible. Density has been improved by the use of silica and superplasticizers, for example. The effect obtained has been purely physical, i.e. it has been based on the diffusion of water and thus the chloride ions in the pores of the concrete. If it has been impossible to adequately limit the diffusion of chlorides in concrete designed for a saline environment, it has been necessary to resort, for example, to the use of expensive stainless or epoxy-coated steels. Harbour structures, oil-drilling rigs, and road bridges are some of the most typical structures that come in contact with chlorides.

Certain compounds arising in the hydration of cement are also able to bind chlorides to themselves chemically. The most important such chloride-binding compound is so-called Friedell salt, ((CaO)₃Al₂O₃CaCl₂*10H₂O).

Due to the creation of this salt, the penetration of a small amount of chloride, about 0.5% of the quantity of cement, into the concrete generally poses no threat to fresh ordinary concretes. As the concrete ages, the situation changes. When the carbon dioxide in the air reacts with and neutralizes the products of hydration, the Friedell salt also decomposes releasing the chloride ions into the concrete, thus threatening the condition of the steel.

Up until now, no practicable means have been disclosed for preventing chlorides travelling into concrete, by binding them to form chemically stable compounds. The present invention discloses such a possibility.

The above and other advantages and benefits of this invention are achieved in the manner stated to be characteristic in the accompanying Claims.

According to the invention, it has now been observed that, by adding metallic copper or copper compounds, even chloride coming from outside with seawater or antifreeze salt will react with the copper powder added to the concrete, to forms with it compounds of extremely low solubility. Laboratory tests have confirmed the insolubility of the compounds that form.

Some possible reaction equations (1) and (2) are given for the reactions between chloride and metallic copper on the one hand and chloride and copper salt on the other:

2Cu+O₂+2H₂O+xCl⁻→Cu₂(OH)₄₋ₓClₓ+xOH⁻ (1)

2Cu²⁺+4OH⁻+xCl⁻→Cu₂(OH)₄₋ₓClₓ+xOH⁻ (2)

The invention is surprising, because as copper is a nobler metal than iron it should not, according to the traditional conception, oxidize in concrete, but should be even better protected than iron from reacting. The present invention exploits the new information that metallic copper or a copper compound is able, precisely in the presence of chloride, to form a stable compound, with which the chloride finally bonds.

A sufficiently small particle size of the copper powder ensures that the products arising from the reaction of the copper and chloride do not cause. detrimental local expansion in the concrete.

The copper powder can be batched like any other fine aggregate, because the reactions of the metallic copper are slow and the copper powder has no chemical effect on the concrete mass or on the properties of the fresh concrete. The batching quantities can be decided in individual cases, i.e. batching can be as much as several tens of percent of the amount of cement.

The method has several applications, for example, when repairing a concrete structure into which chloride has already penetrated, it is possible to use a repair grout containing copper, which will bind to itself not only the new chloride penetrating the structure, but also the chloride that has also previously entered the structure.

The method also permits the use of copper compounds instead of, or in combination with metallic copper, if this is justified in terms of both concrete technology and cost.

1. A method for protecting reinforcement in concrete from corrosion caused by chloride ions, characterized in that, during its manufacturing stage or at a later stage, metallic copper and/or a copper compound is brought into contact with the concrete mass to react with chlorides and to form salts with a chloride content and of low solubility.

2. A method according to claim 1, characterized in that the copper and/or copper compounds are added to the concrete mass during its manufacturing stage.

3. A method according to claim 1, characterized in that the copper and/or copper compounds are brought in to close contact with the concrete, in the form of a grout or similar material specifically intended for repair.

4. A method according to claim 1, characterized in that a sufficient amount of the copper and/or copper compounds is added to achieve a long-term effect.

5. Use of copper/copper compounds in concrete and/or grout for protecting of reinforcement steel from corrosion caused by chloride ions.
